(19) United States
(12) Patent Application Publication
(10) Pub. No.: US 2024/0011346 A1
(43) Pub. Date: Jan. 11, 2024

(54) POWERED VEHICLE CLOSURE SYSTEM WITH BACKUP RELEASE

(71) Applicant: STRATTEC POWER ACCESS LLC, Auburn Hills, MI (US)

(72) Inventors: Greg Sproule, Linden, MI (US); Kimpon Ngem, Grant Township, MI (US); Brian Schymik, Rochester Hills, MI (US); Rick Crandall, Fenton, MI (US)

(21) Appl. No.: 18/348,576

(22) Filed: Jul. 7, 2023

Related U.S. Application Data
(60) Provisional application No. 63/359,318, filed on Jul. 8, 2022.

(51) Int. Cl. E05F 15/63; E05B 83/34

(52) U.S. Cl. CPC E05F 15/63; E05B 83/34; E05Y 2201/624; E05Y 2900/534

(57) ABSTRACT

A vehicle body closure system for a service port or storage compartment formed in the body. The closure system includes a door coupled to the vehicle body for movement between open and closed positions. A seal between the body and door requires compression for closure. A powered closure device including a motor and rotary output is operable for electrical energization in a powered mode of the closure system to release the door from the closed position, and the powered closure device also provides a powered mode for closing the door. A backup release mechanism is operable in a manual mode of the closure system, without energizing the powered closure device, to release the door. The door is locked closed automatically by a drive connection through which the powered closure device moves the door. The drive connection is maintained and not interrupted when releasing the door via the backup release mechanism.

### CROSS-REFERENCE TO RELATED APPLICATION(S)

This application claims the benefit of priority to co-pending U.S. Provisional Patent Application No. 63/359,318, filed on Jul. 8, 2022, the entire contents of which are incorporated by reference herein.

### BACKGROUND

The present invention relates to service ports on vehicles, for example fuel filler ports or electric charging ports, wherein a door is provided to selectively open or close the service port.

### SUMMARY

In one aspect, the invention provides a vehicle body closure system for a service port or storage compartment formed in the body. The closure system includes a door coupled to the vehicle body for movement between an open position and a closed position. A seal is provided between the vehicle body and the door, the seal sized to require compression for the door to assume the closed position. A powered closure device including a motor and a rotary output is operable for electrical energization in a powered mode of the closure system to release the door from the closed position, and the powered closure device also provides a powered mode for closing the door. A backup release mechanism is separate from the powered closure device and operable in a manual mode of the closure system, without electrical energization of the powered closure device, to release the door from the closed position. The door is locked closed automatically by a drive connection through which the powered closure device moves the door. The drive connection is maintained and not interrupted when releasing the door via the backup release mechanism.

In another aspect, the invention provides a vehicle service port closure system of a vehicle body in which a service port is formed to provide access for replenishment of an energy storage device. The vehicle service port closure system includes a door coupled to the vehicle body for movement between an open position and a closed position, the open position of the door exposing the service port for replenishment of the energy storage device. A seal is provided between the vehicle body and the door, the seal sized to require compression for the door to assume the closed position. A powered closure device including a motor and a rotary output is operable for electrical energization in a powered mode of the vehicle service port closure system to release the door from the closed position. A backup release mechanism is separate from the powered closure device and operable in a manual mode of the vehicle service port closure system, without electrical energization of the powered closure device, to release the door from the closed position without breaking a drive connection between the rotary output of the powered closure device and the door.

In another aspect, the invention provides a vehicle service port closure system of a vehicle body in which a service port is formed to provide access for replenishment of an energy storage device. The vehicle service port closure system includes a door coupled to the vehicle body for movement between an open position and a closed position, the open position of the door exposing the service port for replenishment of the energy storage device. A seal is provided between the vehicle body and the door, the seal sized to require compression for the door to assume the closed position. A powered closure device is coupled through an intermediate linkage to the door and operable for electrical energization in a first mode of the vehicle service port closure system to cinch the door into the closed position. The intermediate linkage is configured to toggle over-center into a locked position that passively maintains the door in the closed position with the seal compressed. A backup release mechanism is separate from the powered closure device and manually operable to toggle the intermediate linkage over-center into an unlocked position that releases compression on the seal.

Other aspects of the invention will become apparent by consideration of the detailed description and accompanying drawings.

### BRIEF DESCRIPTION OF THE DRAWINGS

FIG. 1 is a side view of a vehicle having a body with a service port closure system according to one aspect of the invention.

FIG. 2 is a detail view of the portion of the vehicle of FIG. 1 having the service port closure system. A door of the service port closure system is closed to cover the service port.

FIG. 3 is top view of the vehicle service port closure system of FIG. 2.

FIG. 4 is a bottom perspective view of the vehicle service port closure system.

FIG. 5 is an end view of the vehicle service port closure system, from an end opposite a hinge end.

FIG. 6 is a top view of a portion of the vehicle service port closure system, wherein the door is closed and a portion of the housing is hidden.

FIG. 7 is a top view similar to FIG. 6, but also showing a gooseneck hinge overlaid, the gooseneck hinge coupling the door to a linkage of a powered mechanism.

FIG. 8 is a detail view of a portion of the gooseneck hinge interfacing with a position sensor. Additionally, FIG. 8 shows a connection portion of the gooseneck hinge for coupling with the linkage of the powered mechanism.

FIG. 9 illustrates the service port closure system with the door in a first, full-closed position. The linkage engages a first fixed stop.

FIG. 10 illustrates the service port closure system with the door in a second, 30-degree open position.

FIG. 11 illustrates the service port closure system with the door in a third, 60-degree open position.

FIG. 12 illustrates the service port closure system with the door in a fourth, 90-degree open position. The linkage engages with a second fixed stop.

FIG. 13 illustrates the service port closure system with the door in the full-closed position. An emergency manual release cable is shown in an at-rest position just prior to actuation for releasing the door in a power-loss condition.

FIG. 14 illustrates the service port closure system with the emergency manual release cable partially actuated.

FIG. 15 illustrates the service port closure system with the emergency manual release cable fully actuated.

FIG. 16 is a perspective view of a vehicle that can include a closure system as shown in FIGS. 1-15, but for a storage compartment door rather than a service port.

### DETAILED DESCRIPTION

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways.

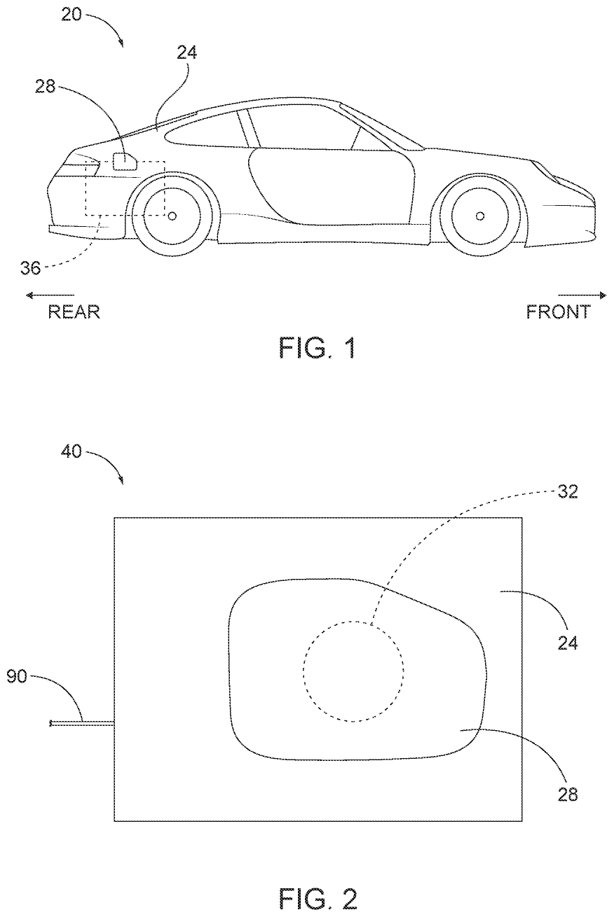

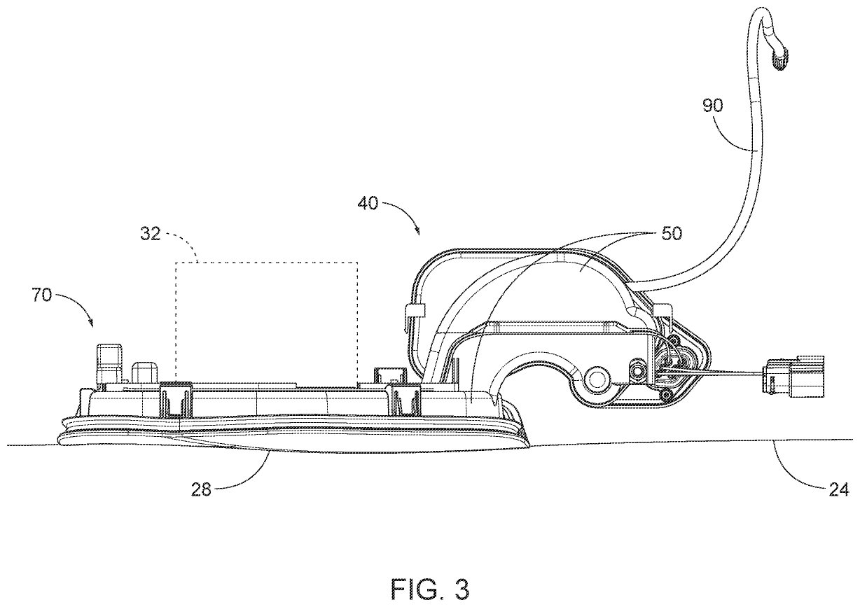

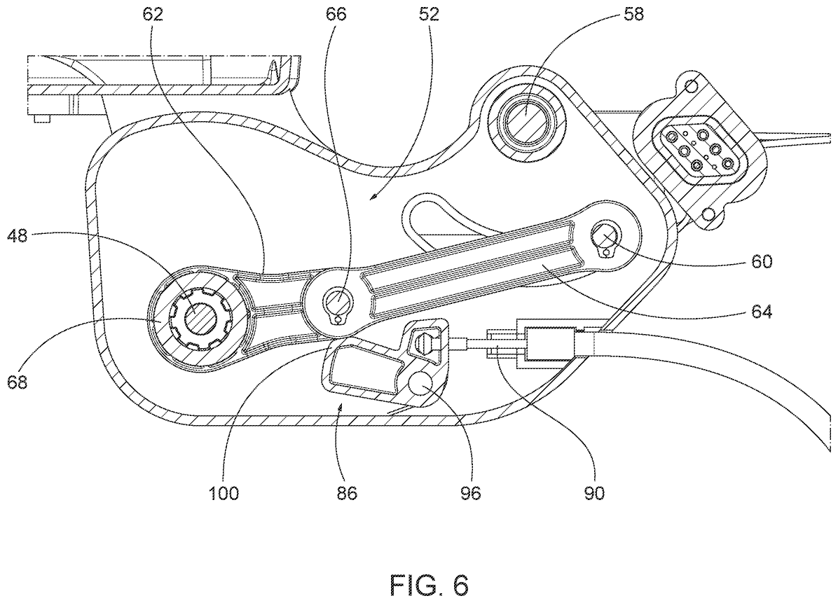

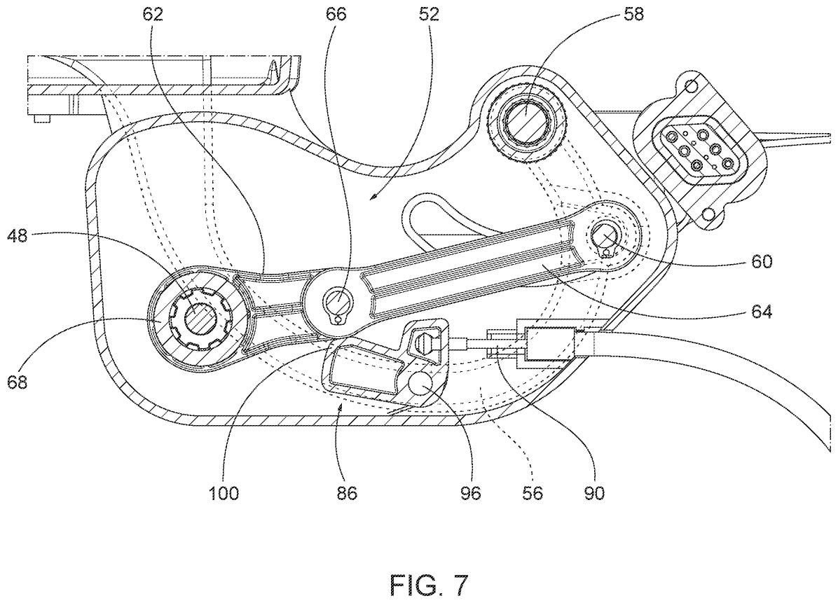

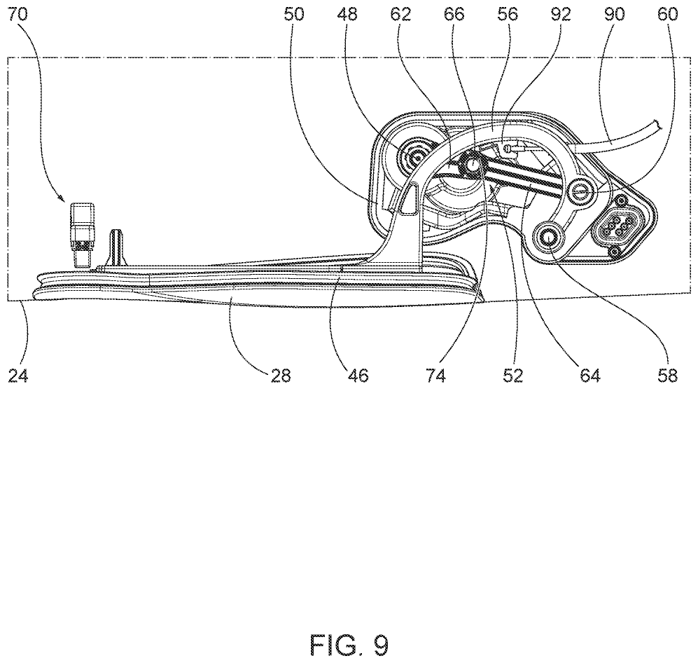

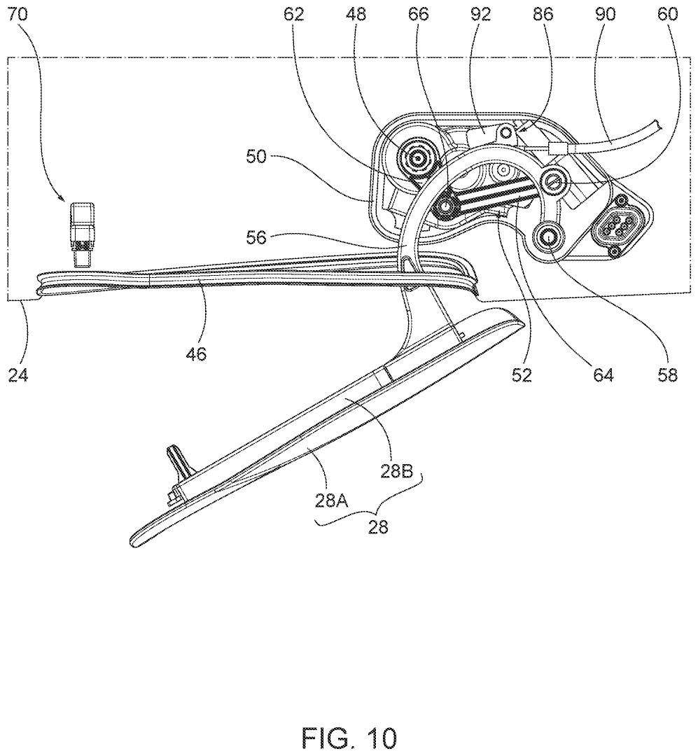

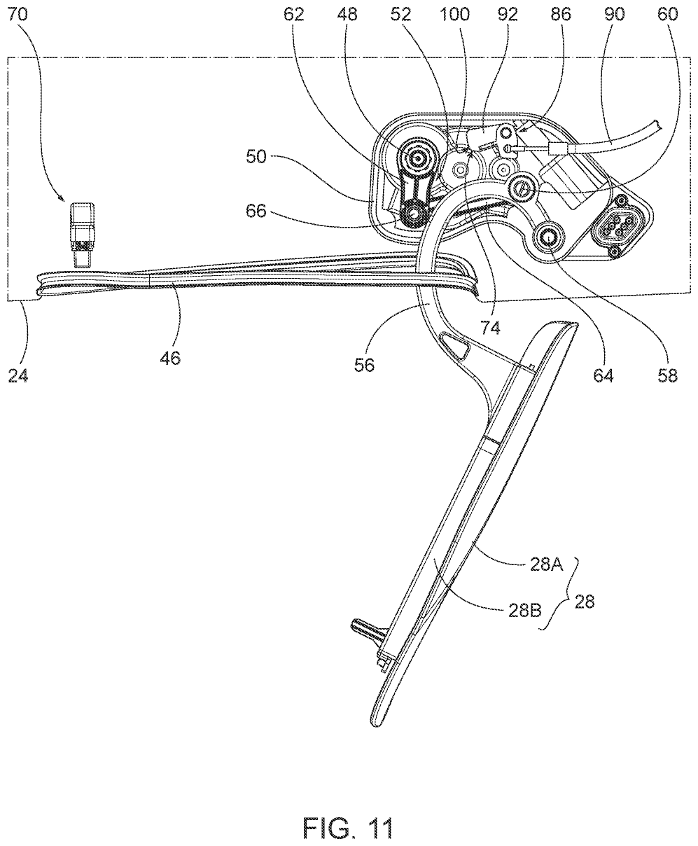

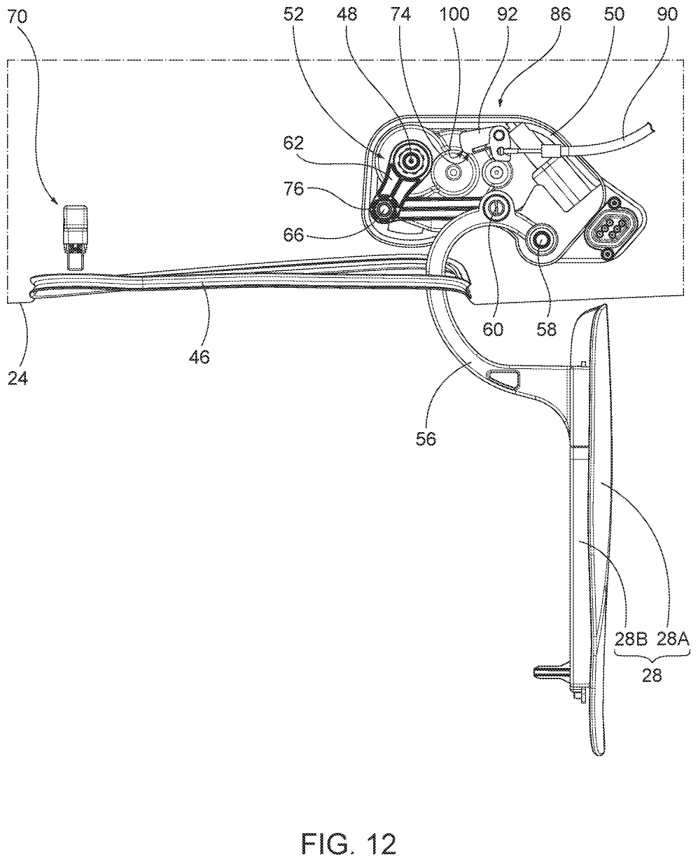

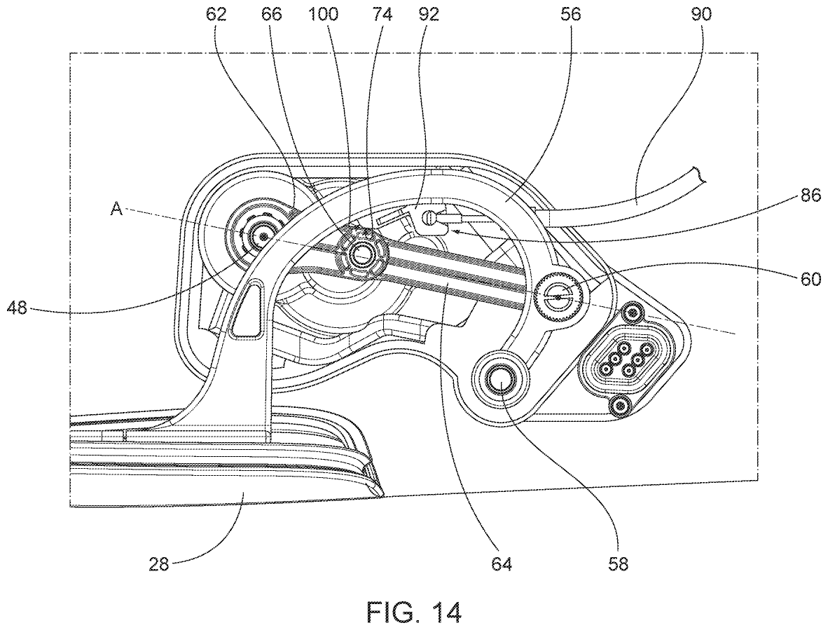

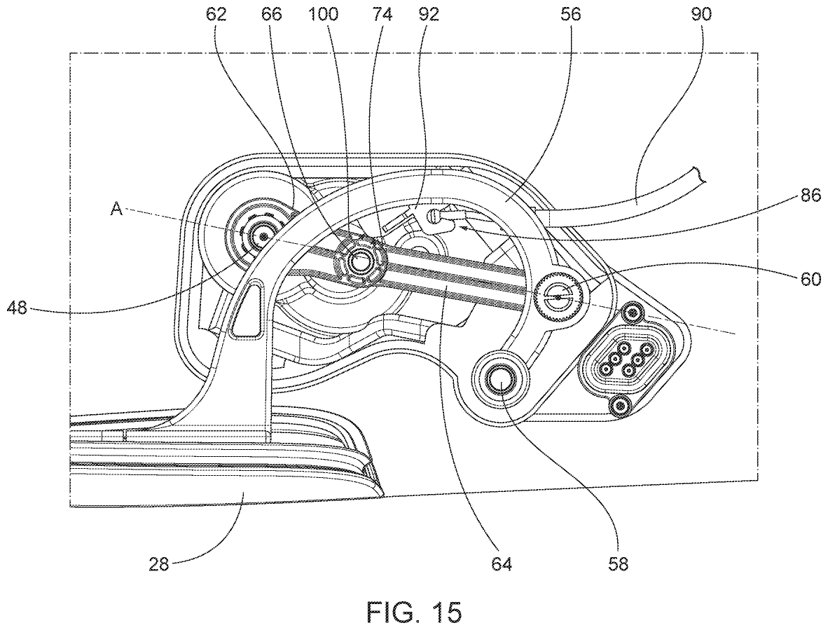

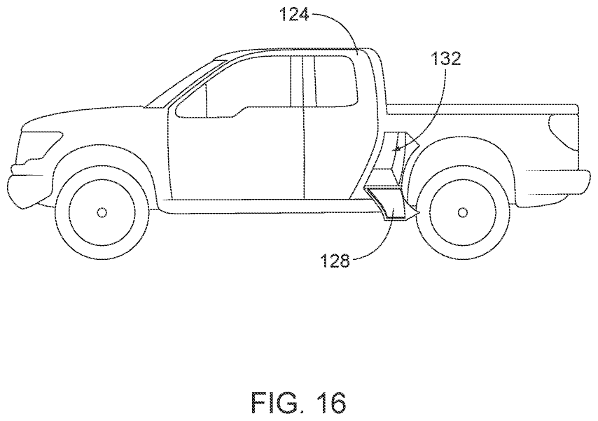

FIG. 1 illustrates a vehicle 20 having a body 24 in which a movable door 28 is provided to selectively access a service port 32 (FIG. 2). The vehicle 20 can be a passenger car as illustrated, or alternately another type of personal or commercial vehicle. The service port 32 can be a fuel filler configured for receiving a fuel nozzle (e.g., at a public filling station), or the service port 32 can alternately be a charge port configured to receive a charging cable (e.g., at a public or private charging station). In other words, depending on the type of propulsion system in the vehicle 20, the service port 32 may provide a receptacle that allows an on-board energy storage device 36 (e.g., a fuel tank or a rechargeable battery pack) to be replenished by the addition of combustible fossil fuel or supply current for recharging of battery cells. FIGS. 2-16 illustrate the door 28 as part of a vehicle service port closure system 40, where only a localized portion of the vehicle body 24 is shown for the sake of convenience. In other constructions, more than one service port is provided within one door and/or one vehicle includes more than one service port door. The door 28 can be flat or contoured on its exterior side, and can match the surface contour of the outside surrounding portion of the body 24. As will be appreciated, especially from FIGS. 9-12, the door 28 swings between a closed position (FIG. 9) and one or more open positions (FIGS. 10-12 where FIG. 12 is a full-open position, which happens to be degrees of rotation from the closed position of FIG. 9). Turning briefly to FIG. 17, it is also noted that the closure system 40 can be adapted for use in some constructions to a door 128 that selectively closes a storage compartment 132 in a vehicle body 124 rather than a service port. FIG. 17 is merely one example. Of course, closure systems according to aspects of the present disclosure can also be used for both service ports and storage compartments on a single vehicle, if desired. As used herein, a storage compartment is a cargo compartment and generally not the human passenger compartment accessible by passenger doors. With the understanding that the features can also be applied to the storage compartment closure system of FIG. 17, the remaining description refers specifically to the illustrated embodiment of the service port closure system.

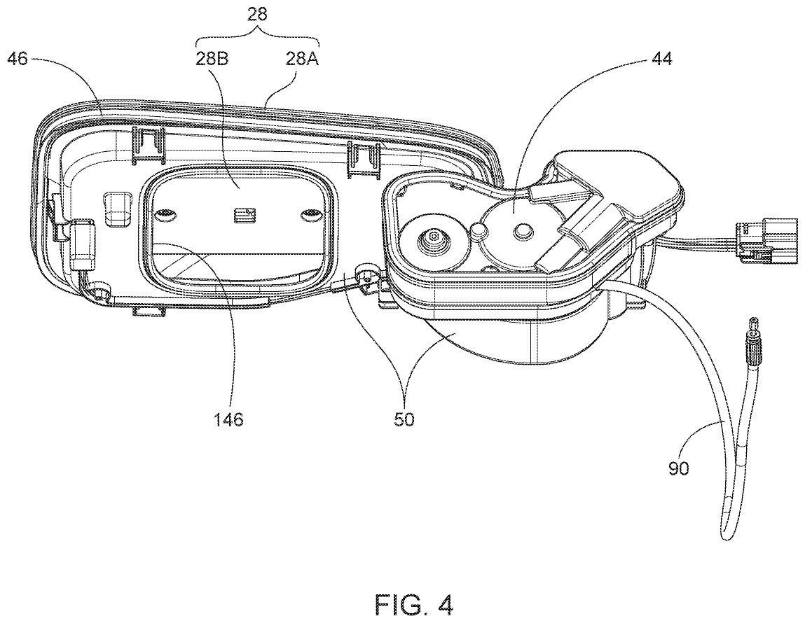

The door 28 can latch securely into the closed position of FIG. 9 and may be powered by a powered actuator 44 or sometimes referred to as a “powered closure device” (e.g., electric motor, direct-drive or with an output geartrain) to move between the various positions (e.g., during opening and/or closing). Operation of the powered actuator 44 can include cinching the door 28 against at least one compressible seal to compress the seal(s) in order to reach the closed position. One example of such a seal 46 is shown in FIG. 4 between an outer periphery of the door 28 and a complementary opening provided in the vehicle body 24 or a fixed housing 50 of the service port closure system 40. The housing 50 is assembled (e.g., snap-fit or fastened) into an opening in the vehicle body 24 to remain stationary therewith. When assembled to the body 24, the housing 50 may be considered to form a part of the body 24, although not necessarily an integral portion of a unitary body shell. As shown in FIG. 10, the seal 46 can remain stationary with the vehicle body 24 (and the fixed housing 50 secured thereto) when the door 28 opens. In other embodiments, the seal 46 can be mounted on the door 28 to move therewith. In some constructions, there may be multiple seals that seal and unseal when closing and opening the door 28. Briefly, FIG. 4 illustrates such an example in which an additional seal 146 is provided between the door 28 and an opening in the fixed housing 50 that accommodates the service port 32. The door 28 can be of multi-piece construction, including an outer panel 28A having an exterior surface situated for continuity along a surrounding portion of the vehicle body 24, and an inner substrate 28B. The inner substrate 28B is situated interior to the outer panel 28A and secured therewith so as to move with the outer panel 28A. The inner substrate 28B can be fixed with or integrally formed as a single piece with the gooseneck hinge 56. The seal(s) 46, 146 can be a flexible polymer material overmolded onto a base substrate, such as the fixed housing 50 or a portion of the door 28. The seal(s) 46, 146 is/are sized to cause interference when closing the door 28. In practice, this interference causes the seal(s) 46, 146 to deflect and conform to the adjacent component, resulting in a sealed interface.

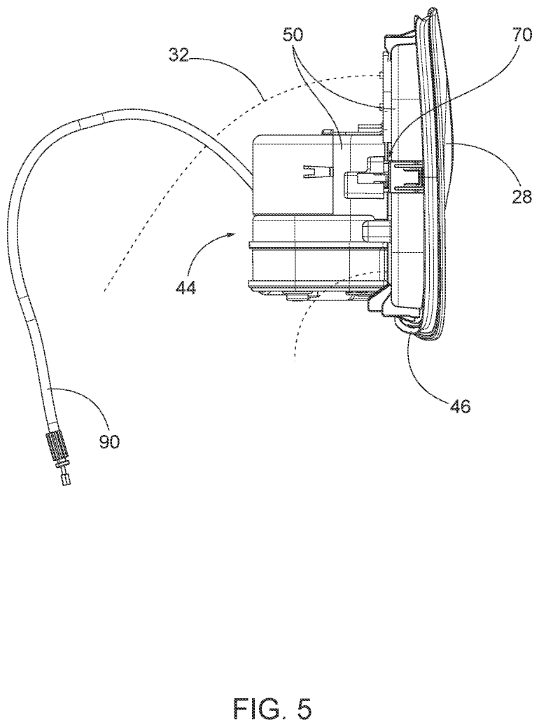

The powered actuator 44, shown in FIGS. 4 and 5, includes a rotary output member 48 which can be in the form of a shaft. The powered actuator 44 is coupled to the door 28 through an intermediate linkage 52 and a gooseneck hinge 56. The gooseneck hinge 56 has a fixed pivot 58, and a connection portion 60 at which the gooseneck hinge 56 is coupled with the intermediate linkage 52. The intermediate linkage 52 includes a drive link 62 and a drag link 64. The drive and drag links 62, 64 have a pivot connection (e.g., fixed pin connection) at 66. In other constructions, the door 28 is hinged to the vehicle body in another manner, such as a four-bar linkage. At the point of connection between the rotary output member 48 and the drive link 62, there can be an intermediate tolerance ring 68 configured to provide relative movement, or slip, only in the event of abusive force to the door 28. The tolerance ring 68 otherwise provides a friction drive connection whereby the drive link 62 rotates synchronously with the rotary output member 48 about a shared axis.

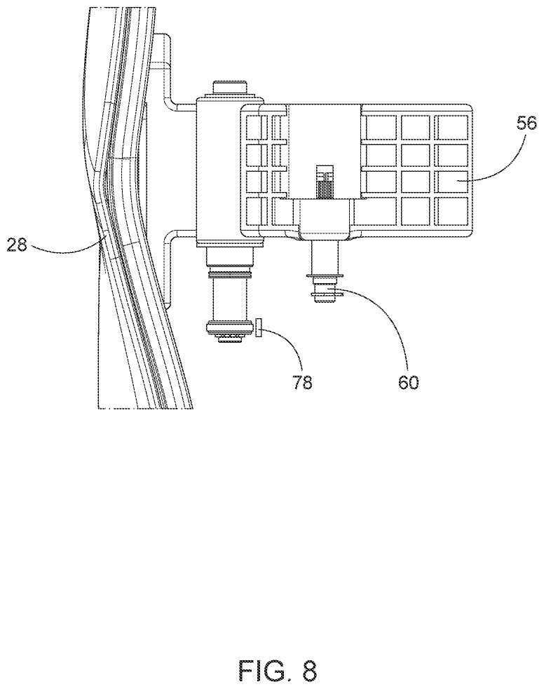

A controller in communication with the powered actuator 44 can be programmed to drive the powered actuator 44 in an opening direction to open the door 28 from the closed position of FIG. 9 to the open position of FIG. 12 (either 90 degrees of rotation as shown or another suitable angle). The controller can be triggered by an input device (e.g., physical momentary switch, touch screen, etc.) within the vehicle interior, or on a key fob for example. However, in lieu of remote actuation, the door 28 can be locally triggered to open via the powered actuator 44 in response to a signal from a detector 70 (FIG. 5), which can comprise a microswitch and a plunger in some constructions. In some constructions, the controller can be programmed to respond to the detector 70 only when the vehicle's passenger doors are unlocked. The detector 70 can have an operating threshold (e.g., 1 mm or 2 mm) whereby the detector is operable to detect and be actuated by a press of the door 28 from the exterior side, which moves the plunger. The press can cause a slight inward movement (e.g., 5 mm or less) of at least a portion of the door 28, and this inward movement can be accommodated by an increased deflection in the seal(s) 46, 146 beyond the normal amount of deflection for the closed position. In response, the powered actuator 44 is controlled to be energized (from an on-board battery of the vehicle 20) to drive rotation of the rotary output member 48 and with it the drive link 62. This in turn drives the drag link 64. From the connection portion 60, the drag link 64 drives rotation of the gooseneck hinge 56 about its fixed pivot 58. This is a powered operational mode for door opening. Throughout movement of the door 28, absolute position of the door 28 can be tracked and reported to the controller by a sensor 78 (FIG. 8). This can enable confirmation of success in opening the door 28, or alternately, detection of a malfunction (e.g., obstacle). As can be observed from FIG. 9, the intermediate linkage 52 has a first travel limit by contact (e.g., of the drag link 64) with a first fixed stop 74 (e.g., of a cam 92—described below, or of the housing 50) to define the closed position. As can be observed from FIG. 12, the intermediate linkage 52 has a second travel limit by contact (e.g., of the drive link 62 and/or the drag link 64) with a second fixed stop 76 (e.g., of the housing 50) to define the maximum open position.

Powered closing of the door 28 can also be triggered by an input device in the vehicle interior or key fob—either the same input device for opening or a different input device. Powered closing is a mode in which the powered actuator 44 is energized to drive the drive link 62 in a closing direction opposite the opening direction. In lieu of operation of a remote input device closing command, contact to the door 28 in the closing direction may also be configured to trigger the powered closing mode of operation. Absolute position of the door 28 can be observed with the sensor 78 to trigger the powered closing. Alternately, or in addition, the closure system can incorporate a door force sensor. As illustrated, the position sensor 78 can be a non-contact position sensor positioned along or in-line with the fixed pivot 58 of the gooseneck hinge 56. As with powered opening, the position sensor 78 can enable confirmation of success in closing the door 28, or alternately, detection of a malfunction (e.g., obstacle). As described in further detail below, normal closing-direction operation of the powered actuator 44 (and nothing more) automatically locks the door 28 upon reaching the closed position.

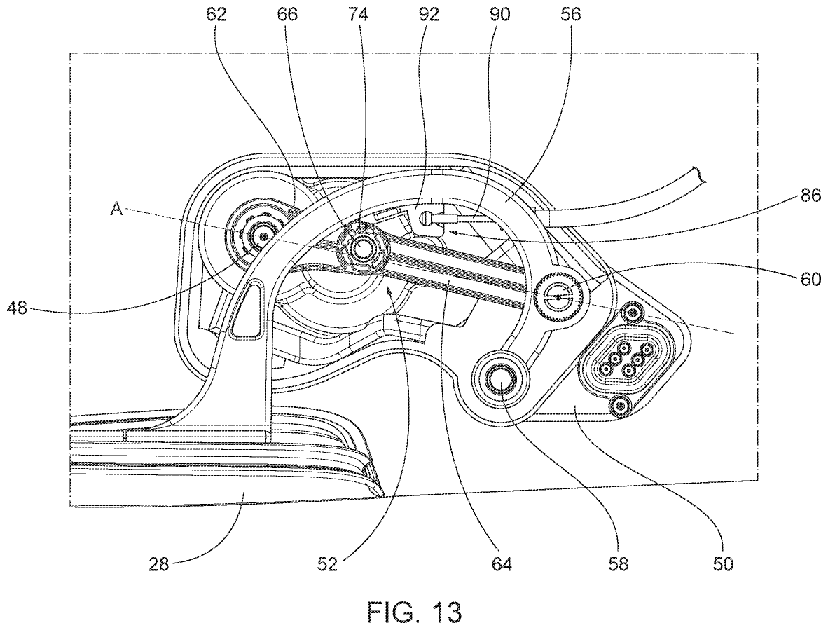

FIG. 13 shows an enlarged view of the position of the intermediate linkage 52 corresponding to the closed position of the door 28. As shown there, the pivot connection 66 between the drive and drag links 62, 64 has crossed over a reference line A drawn between the respective distal pivot axes of the drive and drag links 62, 64 (at the axis of the rotary output member 48 and the axis of the connection portion 60, respectively). Looking at the door closing process (i.e., going in reverse from FIG. 12 to FIG. 9), it will be appreciated that the pivot connection 66 remains on one side of the reference line A throughout all positions up until the final closed position is approached and achieved. In other words, the intermediate linkage 52 is configured to toggle over-center in order to reach the closed position. As such, the closed position is a locked or latched position whereby the intermediate linkage 52 acts to passively maintain the door 52 in the closed position. The over-center toggle action even acts to maintain compression of the seal(s) 46, 146, which may be sized to require elastic deflection in order for the door 28 to assume the closed position. Due to the over-center toggle action of the intermediate linkage 52, an opening-direction force applied to the door 28 or the gooseneck hinge 56 does not tend to drive the linkage 52 toward the releasing direction or open position, but actually only further urges the linkage 52 toward the closing direction—toward the first fixed stop 74 for the closed position of FIG. 9. Thus, it can be said that the intermediate linkage 52 securely locks the door 28 closed. Other than the intermediate linkage 52, there is no separate latch or lock device for preventing opening of the door 28. In other words, the door 28 is positively retained closed and effectively locked solely by the over-center toggling of the intermediate linkage 52, as driven by rotation of the powered actuator 44. The over-center locked position of the intermediate linkage 52 must be undone or reversed in order for the intermediate linkage 52 to be “unlocked” to a state that allows movement of the door 28 to the open position.

Operating in the normal powered opening mode, the intermediate linkage 52 relies on the backward driving rotation of the rotary output member 48 from the powered actuator 44. This is directly responsible for returning the pivot connection 66 over the reference line A so that it can move freely back toward the open position. However, in the event of a loss of functionality of the powered actuator 44, such as a dead battery, there is provided a fully mechanical backup for releasing the over-center position of the intermediate linkage 52 to enable the door 28 to be manually pulled open. In the illustrated construction, the fully mechanical backup or “emergency release” is provided by way of a release mechanism 86 separate from the powered actuator 44 to provide a manual mode of operation. The release mechanism 86 operates on the intermediate linkage 52 without disconnecting any element thereof between the powered actuator 44 and the door 28. In the illustrated construction, the backup release mechanism 86 includes a Bowden cable 90 and a cam 92 engaged by an end of the Bowden cable 90 so that the cam 92 is movable by pulling the Bowden cable 90. As shown, the cam 92 is pivotally supported on the housing 50 about a fixed pivot shaft 96, although other constructions are also contemplated. The cam 92 has a lobe portion 100 sized to contact the intermediate linkage 52 (e.g., in the area of the pivot connection 66 between the drive and drag links 62, 64) and drive the pivot connection 66 back across the reference line A when the Bowden cable 90 is pulled. FIGS. 13-15 illustrate the sequence of pulling the Bowden cable 90. The Bowden cable 90 can have another end, remote from the cam 92, that is provided within the vehicle body 24 or another discreet and/or secured location (e.g., covered by a removable trim panel) for selective access and operation by an operator of the vehicle 20. Once the backup release mechanism 86 is actuated, the vehicle operator can simply pull the door 28 open. The intermediate linkage 52 remains connected between the door 28 and the powered actuator 44, which is configured to enable back-driving so as to not prevent the door 28 from being opened in the emergency situation. The powered actuator 44 may be back-drivable all the way to the electric motor or alternately via slip in a slip clutch between the electric motor and the intermediate linkage 52.

In a construction where security of access to the service port 32 is deemed less critical, the mechanical release mechanism can be operable from the exterior of the vehicle body 24. In some constructions, the mechanical release mechanism, rather than being used only in an emergency situation where power is lost, may be used in conjunction with a powered mode. For example, the cam 92 or a similar element may be actuated to release the over-center position of the intermediate linkage 52 in response to an inward press on the outside of the door 28. Such an inward press can further compress the seal 46 in relation to its normally compressed state for the closed position, and this inward movement can optionally be used as a trigger to energize the powered actuator 44 to run the opening cycle. In other constructions, the inward press simply releases the over-center position of the intermediate linkage 52 to enable the manual opening of the door 28. The powered actuator 44 may still provide power close movement and power cinching to the closed, seal-compressing position. In this or other embodiments, the powered actuator 44 can provide obstacle detection to limit or abort a power-driven movement of the door 28.

Various features and advantages of the invention are set forth in the following claims.

What is claimed is:

1. A vehicle body closure system for a service port or storage compartment formed in the body, the vehicle body closure system comprising:
a door coupled to the vehicle body for movement between an open position and a closed position;
a seal provided between the vehicle body and the door, wherein the seal is sized to require compression for the door to assume the closed position;
a powered closure device including a motor and a rotary output, the powered closure device operable for electrical energization in a powered mode of the closure system to release the door from the closed position, wherein the powered closure device also provides a powered mode for closing the door; and
a backup release mechanism separate from the powered closure device and operable in a manual mode of the closure system, without electrical energization of the powered closure device, to release the door from the closed position
wherein the door is locked closed automatically by a drive connection through which the powered closure device moves the door, and
wherein the drive connection is maintained and not interrupted when releasing the door via the backup release mechanism.

2. The vehicle body closure system of claim 1, wherein the backup release mechanism is operable by pulling a cable to release an over-center linkage of the drive connection from a locked position.

3. The vehicle body closure system of claim 1, wherein the door is coupled to the vehicle body through a gooseneck hinge.

4. The vehicle body closure system of claim 1, wherein the door selectively covers and prevents access to a fuel filler configured for receiving a fuel nozzle.

5. The vehicle body closure system of claim 1, wherein the door selectively covers and prevents access to a charge port configured for receiving a charging cable.

6. The vehicle body closure system of claim 1, wherein the door selectively covers and prevents access to a storage compartment provided in the vehicle body.

7. The vehicle body closure system of claim 1, wherein, in a second powered mode of the closure system, the powered closure device is operable to cinch the door into the closed position.

8. The vehicle body closure system of claim 7, wherein the powered closure device is coupled through an intermediate linkage to the door, wherein the intermediate linkage is configured to toggle over-center into a locked position by actuation of the powered closure device to passively maintain the door in the closed position with the seal compressed, and wherein the backup release mechanism is operable to toggle the intermediate linkage over-center into an unlocked position.

9. A vehicle service port closure system of a vehicle body in which a service port is formed to provide access for replenishment of an energy storage device, the vehicle service port closure system comprising:
a door coupled to the vehicle body for movement between an open position and a closed position, wherein the open position of the door exposes the service port for replenishment of the energy storage device;
a seal provided between the vehicle body and the door, wherein the seal is sized to require compression for the door to assume the closed position;
a powered closure device including a motor and a rotary output, the powered closure device operable for electrical energization in a powered mode of the vehicle service port closure system to release the door from the closed position; and
a backup release mechanism separate from the powered closure device and operable in a manual mode of the vehicle service port closure system, without electrical energization of the powered closure device, to release the door from the closed position without breaking a drive connection between the rotary output of the powered closure device and the door.

10. The vehicle service port closure system of claim 9, wherein the service port selectively exposed by the door is a fuel filler configured for receiving a fuel nozzle.

11. The vehicle service port closure system of claim 9, wherein the service port selectively exposed by the door is a charge port configured for receiving a charging cable.

12. The vehicle service port closure system of claim 9, wherein the backup release mechanism is operable by pulling a cable to release an over-center linkage of the drive connection from a locked position.

13. The vehicle service port closure system of claim 9, wherein the door is coupled to the vehicle body through a gooseneck hinge.

14. The vehicle service port closure system of claim 9, in a second powered mode of the closure system, the powered closure device is operable to cinch the door into the closed position.

15. The vehicle service port closure system of claim 14, wherein the powered closure device is coupled through an intermediate linkage to the door, wherein the intermediate linkage is configured to toggle over-center into a locked position by actuation of the powered closure device to passively maintain the door in the closed position with the seal compressed, and wherein the backup release mechanism is operable to toggle the intermediate linkage over-center into an unlocked position.

16. A vehicle service port closure system of a vehicle body in which a service port is formed to provide access for replenishment of an energy storage device, the vehicle service port closure system comprising:
a door coupled to the vehicle body for movement between an open position and a closed position, wherein the open position of the door exposes the service port for replenishment of the energy storage device;
a seal provided between the vehicle body and the door, wherein the seal is sized to require compression for the door to assume the closed position;
a powered closure device coupled through an intermediate linkage to the door and operable for electrical energization in a first mode of the vehicle service port closure system to cinch the door into the closed position, wherein the intermediate linkage is configured to toggle over-center into a locked position that passively maintains the door in the closed position with the seal compressed; and
a backup release mechanism separate from the powered closure device and manually operable to toggle the intermediate linkage over-center into an unlocked position that releases compression on the seal.

17. The vehicle service port closure system of claim 16, wherein the intermediate linkage alone, without any additional latching or locking mechanism, is responsible for holding the door locked in the closed position.

18. The vehicle service port closure system of claim 16, wherein the backup release mechanism is operable by pulling a cable.

19. The vehicle service port closure system of claim 16, wherein the door is coupled to the vehicle body through a gooseneck hinge.

20. The vehicle service port closure system of claim 16, wherein the energy storage device is a fuel tank and the service port is a fuel filler configured for receiving a fuel nozzle.

21. The vehicle service port closure system of claim 16, wherein the energy storage device is a rechargeable battery pack and the service port is a charge port configured for receiving a charging cable.

22. The vehicle service port closure system of claim 16, wherein the powered closure device is operable in a second mode to drive the door into the open position through the intermediate linkage.
